(19) United States
(12) Patent Application Publication
(10) Pub. No.: US 2017/0218700 A1
(43) Pub. Date: Aug. 3, 2017

(54) CORDLESS HEIGHT ADJUSTMENT MECHANISM FOR WINDOW COVERINGS

(71) Applicant: Whole Space Industries LTD, Taipei (TW)

(72) Inventor: Tzu-Yen Lin, Taipei (TW)

(21) Appl. No.: 15/403,449

(22) Filed: Jan. 11, 2017

Related U.S. Application Data
(60) Provisional application No. 62/340,031, filed on May 23, 2016.
(60) Provisional application No. 62/319,858, filed on Apr. 8, 2016.
(60) Provisional application No. 62/289,569, filed on Feb. 1, 2016.

(51) Int. Cl. E06B 9/78; E06B 9/42; E06B 9/60; E06B 9/264

(52) U.S. Cl. CPC E06B 9/78; E06B 9/264; E06B 9/42; E06B 9/60

(57) ABSTRACT

A window covering can be configured to facilitate height adjustment of window covering material. In some embodiments, a wand may be utilized to help control adjustment of the position of the window covering material. For instance, in some embodiments a roller may be rotated via use of a wand to effect adjustment of the window covering material.

### CROSS-REFERENCE TO RELATED APPLICATIONS

This application claims priority to U.S. Provisional Patent Application No. 62/289,569, filed on Feb. 1, 2016, U.S. Provisional Patent Application No. 62/319,858, filed on Apr. 8, 2016, and U.S. Provisional Patent Application No. 62/340,031, filed on May 23, 2016. The entirety of U.S. Provisional Patent Application No. 62/289,569 is incorporated herein by reference. The entirety of U.S. Provisional Patent Application No. 62/319,858 is incorporated herein by reference. The entirety of U.S. Provisional Patent Application No. 62/340,031 is incorporated herein by reference.

### FIELD OF THE INVENTION

The present invention relates to window coverings such as roll-up shades, mechanisms for controlling the raising and lower of roll-up shades, and methods of making and using the same.

### BACKGROUND OF THE INVENTION

Examples of roll-up shades can be appreciated from U.S. Pat. Nos. 6,860,312 and 7,086,446. Roll-up shades often include a panel of window covering material attached at its top edge to a headrail. Two or more looped lift cords extend from the headrail down a front face of the panel of window covering material, around the bottom edge of the panel and up an opposite rear face of the panel of window covering material into the headrail. The lift cords may then pass through a cord lock in the headrail or wind around a cord collector within the headrail that is coupled to a spring motor, electric motor, or a loop cord drive. Movement of the lift cords into the headrail can cause the panel of window covering material to roll-up as the window covering material is raised and movement of the lift cords out of the headrail can cause the window covering material to unroll as it is lowered. The looped lift cords are spaced apart from one another. The number of looped lift cords can typically depend upon the width of the window covering material but most, if not all, conventional roll-up shades have at least two looped lift cords.

In recent years there has been an increased concern in the window covering industry about child safety as it relates to exposed cords. For instance, there have been instances involving some types of blinds in which a child's head and neck have become entangled in a cord loop that is used to raise and lower the blind. Roll-up shades often have looped lift cords in which the panel of window covering material is captured. Some have observed that the exposed looped lift cords in a conventional roll-up shade could pose the same danger as lift cord loops that are can be formed in connection with other types of blinds such as a venetian blind.

### SUMMARY OF THE INVENTION

I have determined that a new mechanism is needed to provide a means by which window covering material can be rolled up for raising of a window covering and unrolled for lowering of a window covering. A new window covering is provided and a new method of adjusting a position of window covering material of a window covering is also provided. Some embodiments of the window covering can be configured as a cordless roll-up shade. Embodiments of the window covering can be configured so that the unrolling, or lowering, of the window covering material as well as the rolling up, or raising, of the window covering material can occur without the use of any exposed lift cords so that lift cord entanglements can be avoided. In some embodiments, the window covering can be configured so that the window covering can be made for a relatively low cost by not including any lift cords and not including a spring motor, electric motor, loop cord drive, or other type of lift cord control mechanism coupled to such lift cords for controlling the positioning of window covering material.

In some embodiments, a window covering can include a first rail and window covering material that is connected to the first rail such that the window covering material is moveable between a first position (e.g. a fully extended position or a substantially extended position) and a second position (e.g. a retracted position or a substantially retracted position). A first lower portion of the window covering material and a second portion of the window covering material can be rolled up when the window covering material is in the second position (e.g. a fully retracted position or a partially retracted position). A third portion of the window covering material may be located above the first and second portions of the window covering material when the window covering material is in the second position.

A window covering is also provided that includes a first shaft having a first end and a second end opposite the first end and window covering material connected to the first shaft such that the window covering material is moveable between a first position and a second position. A first lower portion of the window covering material and a second portion of the window covering material can be rolled up when the window covering material is in the second position and a third portion of the window covering material can be located above the first and second portions of the window covering material when the window covering material is in the second position. A first mounting device can be coupled to the first shaft adjacent to the first end of the first shaft and a second mounting device can coupled to the first shaft adjacent to the second end of the first shaft. A rotatable disc can be coupled to one of the first end and the second end of the first shaft such that rotation of the disc in a first direction drives rotation of the first shaft in the first direction to wind the window covering material about the first shaft and rotation of the disc in a second direction that is opposite the first direction drives rotation of the first shaft in the second direction to unwind the window covering material from the first shaft. An elongated want can be coupled to the disc such that the elongated wand extends from the disc.

The first lower portion of the window covering material and the second portion of the window covering material can be rolled up when the window covering material is in the first position and the third portion of the window covering material can be located above the first and second portions of the window covering material when the window covering material is in the first position. A rod or bar can be attached to the first portion of the window covering material such that the window covering material encircles the rod or bar.

A spring can be connected between the disc and the first shaft to bias the disc to rotate in the first direction. The spring may be entirely within the first shaft or may be at least partially within the first shaft. For instance, the spring can be connected within the first shaft between the disc and the first shaft. The spring can be configured to bias the disc to rotate in the first direction. In some embodiments, the spring can be configured such that a biasing force provided by the spring to bias the disc to rotate in the first direction is insufficient at driving rotation of the disc without an external rotational force being applied to the disc via the wand.

The first mounting device and the second mounting device can each comprise an annular body that has an inner opening sized to receive a portion of the first shaft. In some embodiments, the annular body can be defined by a part that is moveable relative to another part of the body so that body is adjustable from an open position to a closed position.

The disc can be a plate, a member, or other structure of any type of shape. For instance, the disc may have a circular shape, a polygonal shape, or an oval shape.

The wand can be connected to the disc at its first end. The first end of the wand may be rotatably connected to the disc. For instance, the first end of the wand may be coupled to the disc via a pivot pin or a universal joint attachment mechanism.

A window covering can also be configured to include a first rail and window covering material having a top portion connected to the first rail such that the window covering material is moveable between a first position and a second position. A first lower portion of the window covering material and a second portion of the window covering material can be rolled up when the window covering material is in the second position. A third portion of the window covering material can be located above the first and second portions of the window covering material when the window covering material is in the second position. The first, second, and third portions of the window covering material may be located below the top portion of the window covering material. A second rail can be connected to a bottom portion of the window covering material. The second rail can have a spring positioned at least partially therein that is adjustable from an engaged position to a disengaged position. The spring can be connected to the second rail to drive rotation of the second rail to facilitate rolling up of the window covering material about the second rail when the spring is in the engaged position.

The bottom portion of the window covering material can be located such that the first, second, and third portions of the window covering material are between the top and bottom portions of the window covering material when the window covering material is fully extended, or fully lowered. It should be understood that, in some embodiments, during rolling up of the window covering material as the window covering is adjusted to a raised position, the outer portions of the rolled up portion of the window covering material may be positioned lower than the bottom portion of the window covering material.

Some embodiments of my window covering can include a first roller having a first end and a second end opposite the first end and window covering material connected to the first roller such that the window covering material is moveable between a first position and a second position. A first portion of the window covering material and a second portion of the window covering material can be rolled up when the window covering material is in the second position and a third portion of the window covering material can be located above the first and second portions of the window covering material when the window covering material is in the second position. A first mounting device coupled to the first roller adjacent to the first end of the first roller and a second mounting device coupled to the first roller adjacent to the second end of the second roller can be included in the window covering. A rotatable disc can be coupled to one of the first end and the second end such that rotation of the disc in a first direction drives rotation of the first roller in the first direction to wind the window covering material about the first roller and rotation of the disc in a second direction that is opposite the first direction drives rotation of the first roller in the second direction to unwind the window covering material from the first roller. An elongated wand can be coupled to the disc such that the elongated wand extends from the disc. A user may grasp the wand to drive rotation of the disc in the first direction and/or the second direction to adjust the position of the window covering material.

The first portion of the window covering material can be rolled up when the window covering material is in the first position and the second portion of the window covering material and the third portion of the window covering material can be located above the first portion of the window covering material when the window covering material is in the first position. The second portion of the window covering material can located between the first portion of the window covering material and the third portion of the window covering material when the window covering material is in the first position of the window covering material. The position of the window covering material can be a user selected position based on use of the wand to drive adjustment of the position of the window covering material.

Embodiments of the window covering can include a bottom rail attached to the first portion of the window covering material or a bottommost portion of the window covering material such that a portion of the window covering material encircles the bottom rail when the first portion of the window covering material is rolled up. The bottom rail can be a bar or rod attached to the first portion of the window covering material such that the window covering material encircles the bar or rod in some embodiments. In other embodiments, the bottom rail may be structured as a tube, a shaft or another type of elongated member.

Embodiments of the window covering can also include a spring connected between the disc and the first roller to bias the disc to rotate in the first direction. In some embodiments, the spring can be positioned within the first roller or be connected within the first roller. The spring can be configured such that a biasing force provided by the spring to bias the disc to rotate in the first direction is insufficient at driving rotation of the disc without an external rotational force being applied to the disc via the wand so that the spring only helps provide some force to assist with adjustment of the window covering material via its biasing force and is not the primary driver of motion of the window covering material. In some embodiments, the spring can be configured so that an amount of biasing force provided by the spring decreases as the disc is rotated in the first direction and the window covering material is wound upon the first roller and the amount of biasing force provided by the spring increases as the window covering material is unrolled from the first roller. In other embodiments, the spring can be configured as a constant force spring.

In some embodiments, the first mounting device can be comprised of an annular body having a central opening. The first roller can pass through the central opening of the body of the first mounting device such that a portion of the first roller is within the central opening and is retained within the central opening. The second mounting device can also be comprised of an annular body having a central opening. The first roller can pass through the central opening of the body of the second mounting device such that a portion of the first roller is within the central opening and retained therein.

The wand can be an elongated member that extends between its opposite ends. For instance, the wand can have a first end and a second end. The first end can be rotatably coupled to the disc so that the first end is rotatable relative to the disc when the disc rotates.

A method of adjusting a position of window covering material of a window covering from a first position to a second position is also provided. Embodiments of the method can include grasping a wand extending from a disc connected to an end of a first roller of the window covering, moving the wand to rotate the disc in a first direction to drive rotation of the first roller in a first direction to wind window covering material onto the first roller, and stopping the moving of the wand to maintain the window covering material at the second position.

The moving of the wand can be performed such that the disc rotates relative to an upper end of the wand that is rotatably connected to the disc.

The method can also include other steps. For instance, the method can also include varying a biasing force of a spring connected between the first roller and the disc as the window covering material is wound upon the first roller. As another example, the method can include lowering the window covering material such that window covering material unwinds from the first roller and varying a biasing force of the spring as the window covering material is lowered.

Other details, objects, and advantages of the window covering and method will become apparent as the following description of certain exemplary embodiments thereof proceeds.

### BRIEF DESCRIPTION OF THE DRAWINGS

Exemplary embodiments of the window covering and methods of making the same are shown in the accompanying drawings. It should be understood that like reference numbers used in the drawings may identify like components.

FIG. 1 is a perspective view of a first exemplary embodiment of my window covering in an extended, or lowered, position.

FIG. 2 is a perspective view of the first exemplary embodiment of my window covering in a partially raised, or partially retracted, position.

FIG. 3 is a fragmentary view of the first exemplary embodiment of my window covering illustrating an exemplary disc coupled to an exemplary first shaft adjacent a first end of the first shaft and a first mounting device while the window covering is in the extended, or lowered, position.

FIG. 4 is a fragmentary view of the first exemplary embodiment of my window covering illustrating an exemplary disc coupled to an exemplary first shaft adjacent a first end of the first shaft and a first mounting device while the window covering is in the partially raised, or retracted, position.

FIG. 5 is a fragmentary view of the first exemplary embodiment of my window covering illustrating an exemplary second end of the first and a second mounting device while the window covering is in the extended, or lowered, position.

FIG. 6 is a fragmentary view of the first exemplary embodiment of my window covering illustrating an exemplary disc coupled to an exemplary first shaft adjacent a first end of the first shaft and a first mounting device while the window covering is in the extended, or lowered, position.

FIG. 7 is another fragmentary view of the first exemplary embodiment of my window covering illustrating an exemplary disc coupled to an exemplary first shaft adjacent a first end of the first shaft and a first mounting device while the window covering is in the extended, or lowered, position.

### DETAILED DESCRIPTION OF EXEMPLARY EMBODIMENTS

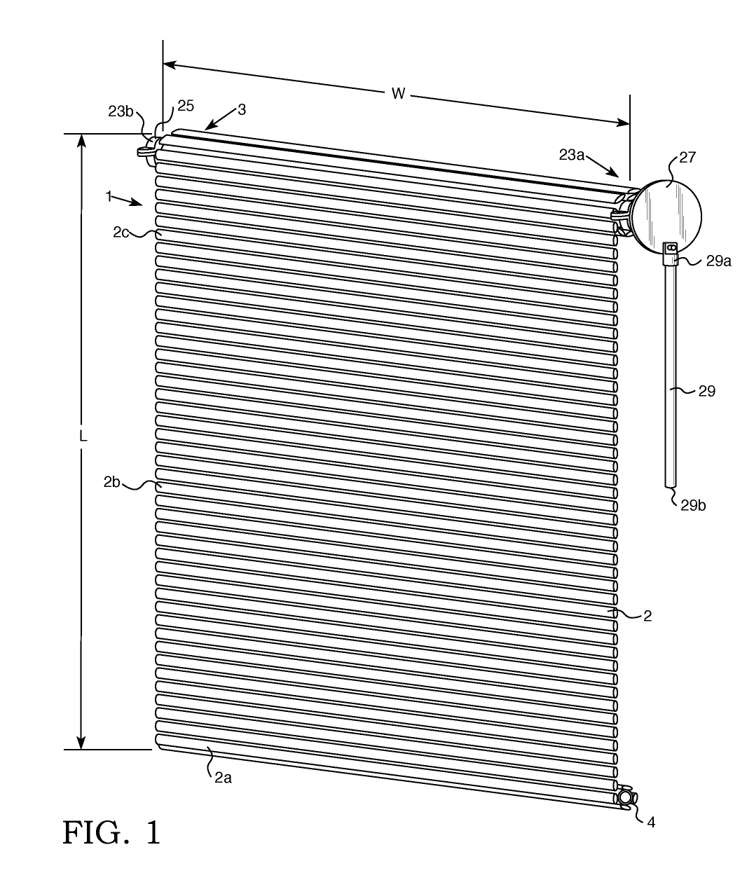

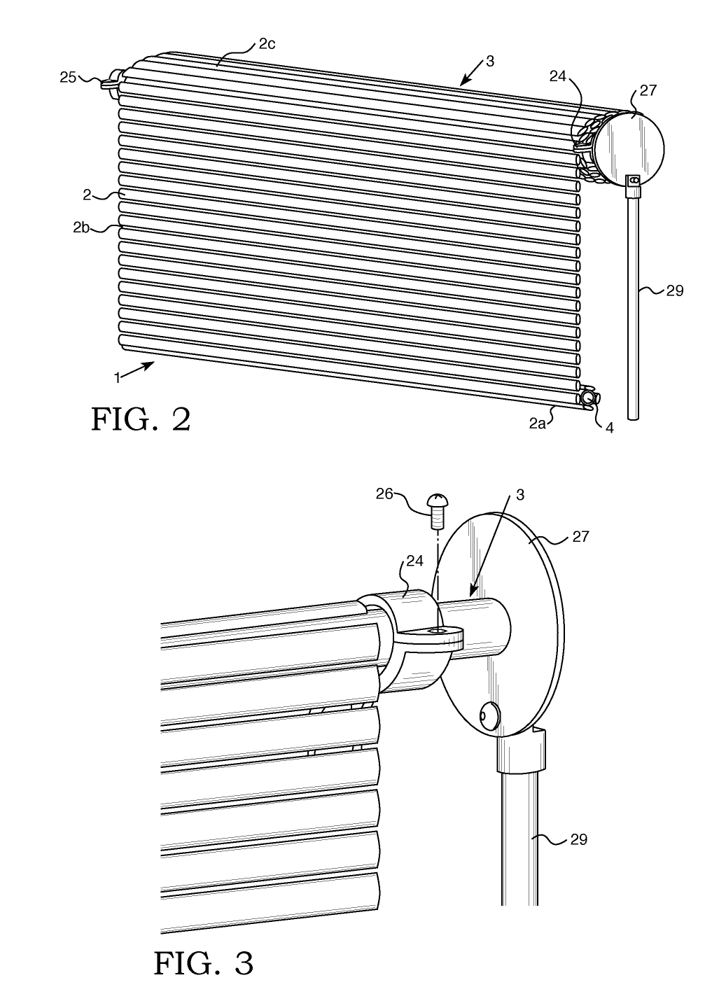

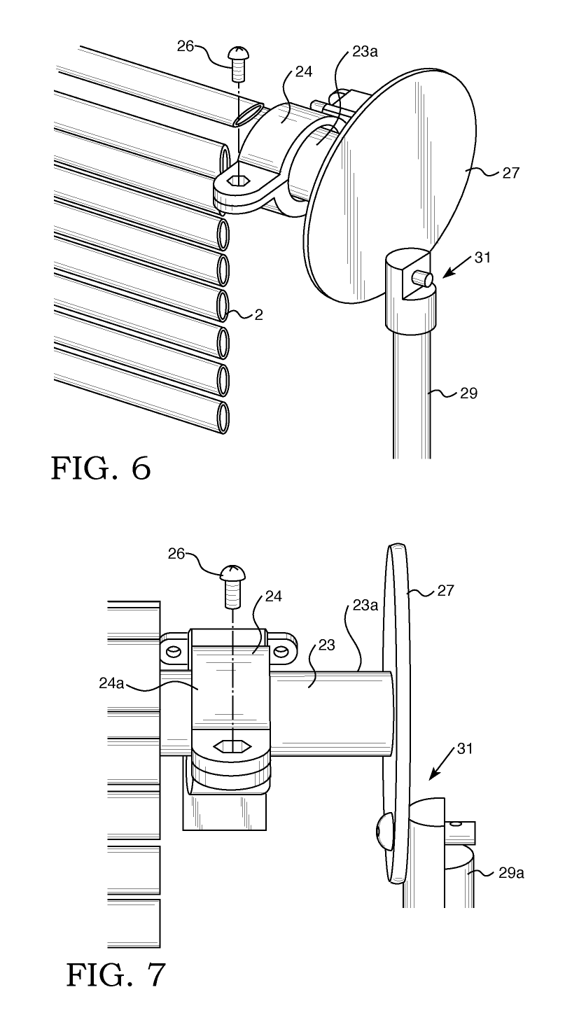

As can be appreciated from FIGS. 1-7, embodiments of the window covering can include a height adjustment mechanism for controlling the raising and lowering of window covering material that permits the window covering material to be raised and lowered without use of lift cords passing through a cord lock and/or without use of any lift cords. In some embodiments, the window covering can be configured as a roll-up shade.

Embodiments of the window covering can be configured so that a window covering functions as a roll-up shade without the use of exposed looped lift cords as needed in a conventional roll-up shade. Such embodiments may also be configured to not utilize a cord lock, operator cord, electric motor, and/or spring motor for controlling the adjustment of the position of the window covering material.

For example, embodiments of my window covering 1 can have window covering material 2 that extends from a first rail 3. A top portion of the window covering material may be connected to the first rail. A bottom portion of the window covering material 2 may be connected to a second rail 4. The first rail 3 may be a headrail or the intermediate rail of a top down bottom up shade. The second rail 4 may be a bottom rail. In some embodiments, it is contemplated that the second rail 4 may not be present.

The window covering material 2 can be moveable from a first position to a second position and may also be moveable to a number of other positions that may be located between the first and second positions. For instance, the window covering material 2 can be configured to be moveable between a fully extended position or a fully lowered position to a fully retracted position or a fully raised position and may also be moved to other positioned between the fully lowered and fully raised positions.

The window covering material 2 can be composed of any number of suitable materials, such as fabric, woven wood, woven bamboo, woven together polymeric slats (e.g. polyvinyl chloride (“PVC”) slats, etc.), or other type of window covering material. The width W of the window covering material may extend from a first side of the window covering material to a second opposite side of the window covering material. The first and second sides may extend along the length L of the window covering material from a top of the window covering material located adjacent the first rail 3 to a bottom of the window covering material located adjacent the bottom rail 4. The first rail 3 can be structured as a shaft, tube, bar, or other elongated member composed of metal, polymeric material, wood, or other type of material. The second rail 4 can also be structured as a shaft, tube, bar, or other type of elongated member composed of metal, polymeric material, wood, or other type of material.

The window covering material 2 can include a first portion 2a, a second portion 2b, and a third portion 2c. The third portion 2c may be located adjacent the first rail, the second portion 2b can be positioned between the first and third portions 2a and 2c. The first portion 2a can be the bottom portion of the window covering material. The window covering material 2 can be coupled to the first rail 3 such that when the window covering material 2 is raised, the first portion 2a of the window covering material rolls up about the bottom rail 4 or about the bottom of the window covering material. The second portion 2b can also be rolled up as the window covering material is moved from its fully extended position to a retracted position. The third portion 2c may be located above the rolled up portion as the window covering material is rolled up during raising of the window covering material. When the window covering material 2 is lowered, the second portion 2b and/or first portion 2a may be unrolled. In some partially extended or partially retracted positions of the window covering material 2, the first portion 2a may be rolled up while the second portion 2b and the third portion 2c is unrolled and located above the rolled up portion of the window covering material. Some embodiments may be configured so that when the window covering material is in a fully extended position, the first portion 2a may be unrolled. Other embodiments can be configured so that when the window covering material is at a fully extended position the first portion 2a may still be in a rolled up position.

The window covering can include a mechanism that is configured to permit manual rotation of a first rail 3. The first rail 3 may be configured as a roller 23 (e.g. a tube, a rod, a cylindrical elongated member, a rotatable elongated member, a rotatable shaft, etc.), that is connected to a first mounting device 24 adjacent a first end 23a of the roller and a second mounting device 25 adjacent a second end 23b of the roller that is opposite its first end 23a. The first and second mounting devices 24 and 25 can be configured as annular shaped mounting brackets that have a body defining an inner hole or opening through which the roller 23 passes through. In other embodiments, the first and second mounting devices 24 and 25 can be another type of mounting bracket. The mounting devices 24 and 25 can be configured to facilitating mounting of the first rail 23 adjacent a window via fastening the mounting devices to a window frame or other structure adjacent a window. One or more fasteners 26 (e.g. screws, nails, bolts, etc.) can be utilized to mount the first rail to that structure via the mounting devices. In some embodiments, each mounting device may have a body that has a moveable portion 24a or 25a that is pivotable about another portion of the body of the mounting device from an open position and a closed position. The moveable portion can be rotated to an open position to receive the roller within the inner opening defined by that body and can be moved to the closed position to fully encircle or substantially encircle the roller within the opening of the body. A fastener (e.g. a pin, bolt, screw, etc.) can be used to help lock the moveable body in its closed position by fastening the moveable portion to the other portion for defining the inner opening.

The first end 23a of the roller 23 can extend from the first mounting device 24 outwardly from that mounting device and have its terminal end coupled to a disc 27. The disc 27 can be coupled to the terminal end of the first end 23a to facilitate rotation of the roller 23 via rotation of the disc 27. For instance, the disc 27 can be coupled to the first end 23a so that rotation of the disc in a first rotational direction (e.g. clockwise or counter clockwise) can cause the roller 23 to rotate in that first rotational direction and rotation of the disc 27 in a second rotational direction that is opposite the first rotational direction (e.g. counter clockwise if the first rotational direction is clockwise or clockwise if the first rotational direction is counter clockwise) causes the roller 23 to rotate in that second rotational direction. Rotation of the roller 23 in the first rotational direction may cause the window covering material 2 to wind about the roller 23 to raise, or retract, the window covering material. Rotation of the roller 23 in the second rotational direction can cause the window covering material to unroll, or unwind, from the roller 23 to extend, or lower the window covering material. A wand 29 can be coupled to the disc 27 so that a user may grasp the want 29 to provide a force for driving rotation of the disc 27. For instance, a first end 29a of the wand 29 can be rotatably connected to the disc 27. The wand may extend downwardly from the disc 27 to its second end 29b. A user may grasp the wand 29 to provide a force for rotating the disc to raise or lower the window covering material 2.

The wand 29 can be rotatably connected to the disc at its first end 29a via a universal joint attachment, pivot pin attachment, or other type of rotatable attachment so that the wand may pivot relative to the disc 27 as the disc 27 is rotated and the first end of the wand 29 travels in a circular path via the rotation of the disc 27. This can permit the wand 29 to be easily grasped by a user as the wand's height changes as the disc 27 rotates due to the wand's connection to the disc.

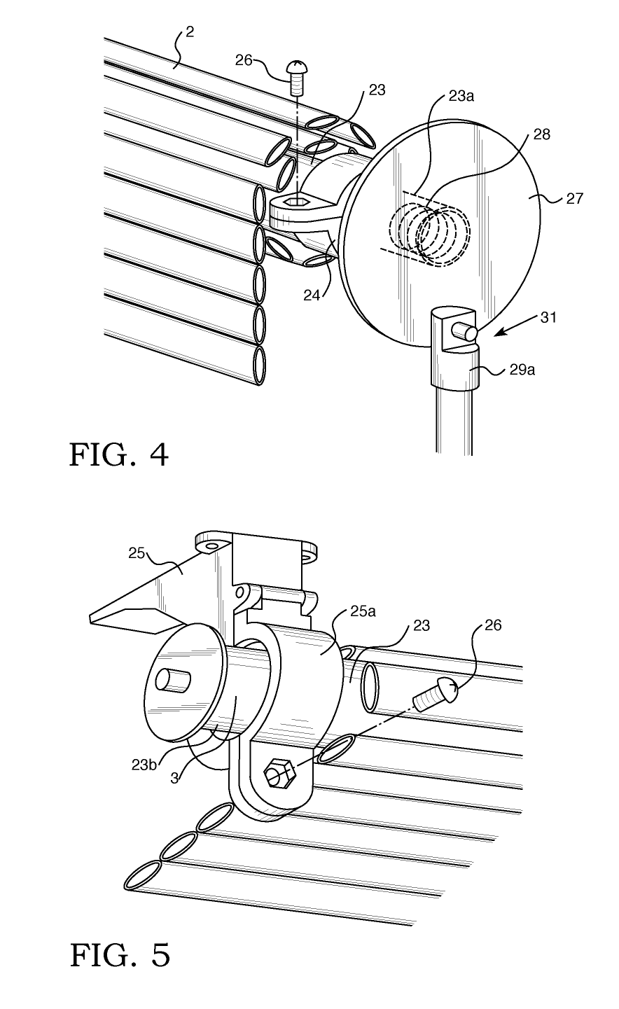

For window covering material 2 that is of a significantly large size or otherwise of a substantial weight, the rotation of the roller 23 via wand 29 and disc 27 may require a substantial amount of force for a user to raise the window covering material. To help aid a user in providing the rotational force, at least one spring 28 (shown in broken line in FIG. 4) may be connected between the disc 27 and the roller 23 to provide a biasing force to bias the roller 23 and disc 27 to rotate in the first rotational direction. That biasing force may not be sufficient to cause the roller 27 to rotate without a force provided by a user on the wand 29 to drive rotation of the disc 27. But, the biasing fore can be enough to help facilitate rotation of the disc 27 in the first rotational direction so that a user only has to provide a force for a part of the weight of the window covering material instead of the entirety of the weight of the window covering material when raising the window covering material 2. Each spring can be located entirely within the roller 23 or may be at least partially within the roller 23. In some embodiments, a first end or side of the spring may be coupled to the roller 23 within the roller (e.g. within a channel or cavity of the roller) and the second end or side of the spring can be coupled to the disc 27 (e.g. a face of the disc 27 that faces toward to first end 23a of the roller 23).

In some embodiments, the spring and/or the connection of the spring between the roller 23 and the disc 27 can be configured as a variable force spring so that as the window covering material 2 is raised, the amount of biasing force provided by the spring decreases and so that as the window covering material is lowered, the amount of biasing force provided by the spring increases. In other embodiments, the spring and/or connection of the spring between the roller and the disc can be configured as a constant biasing force arrangement.

The window covering material 2 can be connected to a second rail 4 (e.g. a tube or a shaft or a bar, etc.) adjacent a bottom of that material to form a rolled up portion of the window covering material at the bottom of the window covering material. In other embodiments, the bottom portion of the window covering material may just be rolled up upon itself and attached together to form the rolled up portion. The bottom rolled up portion may be configured to facilitate an aesthetic appearance so that the window covering appears similar to a roll-up shade. In some embodiments, this rolled up bottom portion may not further roll-up upon itself as the shade material is raised or lowered.

It should be appreciated that embodiments of the window covering and method of making and using the window covering can vary to account for different design objectives. For example, the type of window covering material that is utilized may be any of a desired number of different types of material to provide a desired aesthetic effect and/or a desired insulative property. The material may be sheer, may be light filtering, may be light blocking, or may have other properties as well. As another example, the first rail 3 can be composed of a wood, be an extruded metal rail, or be a polymeric rail and also have any number of different structural shapes and configurations (e.g. an elongated beam, a bar, a rod, etc.). The first rail 3 may have an internal conduit defined therein, may have a channel, or may be a solid structure and have a cross section that is rounded, circular, oval, polygonal, or have another type of shape. In some embodiments, it is contemplated that the first rail 3 may have profiles or connector elements that are configured to receive portions of the clips or a portion of handle 5 so that the handle 5 or clips 7 can be attached to the first rail and extend from the first rail to the rolled up portion of window covering material and/or the second rail 4 when the window covering material is in a fully retracted position, fully raised position, or fully open position. As another example, the second rail 4 can be composed of a wood, be an extruded metal rail, or be a polymeric rail and also have any number of different structural shapes and configurations (e.g. an elongated beam, a bar, a rod, etc.). The second rail 4 may have an internal conduit defined therein, may have a channel, or may be a solid structure and have a cross section that is rounded, circular, oval, polygonal, or have another type of shape. Thus, while certain exemplary embodiments of window covering and methods of making and using the same have been shown and described above, it is to be distinctly understood that the invention is not limited thereto but may be otherwise variously embodied and practiced within the scope of the following claims.

What is claimed is:

1. A window covering comprising:
a first roller having a first end and a second end opposite the first end;
window covering material connected to the first roller such that the window covering material is moveable between a first position and a second position, a first portion of the window covering material and a second portion of the window covering material being rolled up when the window covering material is in the second position, a third portion of the window covering material being located above the first and second portions of the window covering material when the window covering material is in the second position;
a first mounting device coupled to the first roller adjacent to the first end of the first roller;
a second mounting device coupled to the first roller adjacent to the second end of the second roller;
a rotatable disc coupled to one of the first end and the second end such that rotation of the disc in a first direction drives rotation of the first roller in the first direction to wind the window covering material about the first roller and rotation of the disc in a second direction that is opposite the first direction drives rotation of the first roller in the second direction to unwind the window covering material from the first roller;
an elongated wand coupled to the disc such that the elongated wand extends from the disc.

2. The window covering of claim 1, wherein the first portion of the window covering material is rolled up when the window covering material is in the first position and the second portion of the window covering material and the third portion of the window covering material are located above the first portion of the window covering material when the window covering material is in the first position; and
wherein the second portion of the window covering material is located between the first portion of the window covering material and the third portion of the window covering material when the window covering material is in the first position of the window covering material.

3. The window covering of claim 2, comprising:
a bottom rail attached to the first portion of the window covering material such that the window covering material encircles the bottom rail.

4. The window covering of claim 2, comprising:
a bar or rod attached to the first portion of the window covering material such that the window covering material encircles the bar or rod.

5. The window covering of claim 1, comprising:
a spring connected between the disc and the first roller to bias the disc to rotate in the first direction.

6. The window covering of claim 1, comprising:
a spring connected within the first roller between the disc and the first roller, the spring configured to bias the disc to rotate in the first direction.

7. The window covering of claim 5, wherein the spring is configured such that a biasing force provided by the spring to bias the disc to rotate in the first direction is insufficient at driving rotation of the disc without an external rotational force being applied to the disc via the wand.

8. The window covering of claim 1, wherein the first roller is a shaft, a tube, an elongated member, or a bar.

9. The window covering of claim 1, wherein:
the first mounting device is comprised of an annular body having a central opening, the first roller passing through the central opening of the body of the first mounting device; and
the second mounting device is comprised of an annular body having a central opening, the first roller passing through the central opening of the body of the second mounting device.

10. The window covering of claim 9, wherein:
the wand has a first end and a second end, the first end being rotatably coupled to the disc so that the first end is rotatable relative to the disc when the disc rotates.

11. The window covering of claim 10, comprising:
a spring connected between the disc and the first roller to bias the disc to rotate in the first direction.

12. The window covering of claim 11, wherein the spring is configured so that an amount of biasing force provided by the spring decreases as the disc is rotated in the first direction and the window covering material is wound upon the first roller and the amount of biasing force provided by the spring increases as the window covering material is unrolled from the first roller.

13. The window covering of claim 11, wherein the spring is a constant force spring.

14. The window covering of claim 10, comprising:
a spring connected between the disc and the first roller to bias the disc to rotate in the first direction; the spring being configured so that an amount of biasing force provided by the spring decreases as the first roller is rotated in the first direction and the window covering material is wound upon the first roller and the amount of biasing force provided by the spring increases as the window covering material is unrolled from the first roller.

15. A method of adjusting a position of window covering material of a window covering from a first position to a second position, the method comprising:
grasping a wand extending from a disc connected to an end of a first roller of the window covering;
moving the wand to rotate the disc in a first direction to drive rotation of the first roller in a first direction to wind window covering material onto the first roller;
stopping the moving of the wand to maintain the window covering material at the second position.

16. The method of claim 15, wherein the moving of the wand is performed such that the disc rotates relative to an upper end of the wand that is rotatably connected to the disc.

17. The method of claim 16, comprising:
varying a biasing force of a spring connected between the first roller and the disc as the window covering material is wound upon the first roller.

18. The method of claim 17, comprising:
lowering the window covering material such that window covering material unwinds from the first roller.

19. The method of claim 18, comprising:
varying a biasing force of the spring as the window covering material is lowered.

20. The method of claim 19, wherein:
a first portion of the window covering material and a second portion of the window covering material are rolled up when the window covering material is in the second position and an unrolled third portion of the window covering material is located above the first and second portions of the window covering material when the window covering material is in the second position.
